(19) United States
(12) Patent Application Publication
(10) Pub. No.: US 2006/0174990 A1
(43) Pub. Date: Aug. 10, 2006

(54) Inflatable articles having reduced gas permeability

(75) Inventors: Michael O'Neill, Middletown, DE (US); Donald A. Sandusky, Landenberg, PA (US)

Correspondence Address: BAKER BOTTS L.L.P., 2001 ROSS AVENUE, SUITE 600, DALLAS, TX, 75201-2980, US

(73) Assignee: BELL SPORTS, INC.

(21) Appl. No.: 11/323,899

(22) Filed: Dec. 30, 2005

Related U.S. Application Data
(60) Provisional application No. 60/641,049, filed on Jan. 3, 2005.

(51) Int. Cl. B60C 5/00

(52) U.S. Cl. 152/450; 446/220

(57) ABSTRACT

In accordance with the teachings of the present invention, an inflatable article having reduced gas permeability and a method of reducing the gas permeability of an inflatable article are provided. In a particular embodiment of the present invention, the inflatable article is made of approximately 100% polyisobutylene rubber. In accordance with another embodiment of the present invention, a method of reducing the gas permeability of an inflatable article includes inflating the inflating article with carbon dioxide to a first pressure, purging the carbon dioxide from the article, inflating the article with air to a second pressure, the second pressure being higher than the first pressure, maintaining the inflation of the article with air at the second pressure for a predetermined period of time, purging the article of air, and reinflating the article with air.

### BACKGROUND OF THE INVENTION

Elastomeric materials are often used to manufacture inflatable articles, such as bicycle inner tubes. Typically, inflatable articles are manufactured by putting unvulcanized rubber ingredients (including a blend of natural rubber and/or other unsaturated or semi-unsaturated, semi-crystalline polymers) through a kneading/blending process using a Banbury mixer. The mixed rubber is then drawn into a thick film through large rollers that are typically maintained at approximately 70° C. The resulting batch of unvulcanized rubber is aged for a period of time and then broken into workable pieces that are fed into a hot extruder. The rubber is filtered and extruded at temperatures ranging from about 100° C. to about 110° C. The rubber is then cooled and fed into another extruder to be made into tubes that are cooled, cut, and patched with other components, such as a valve patch, to make the desired inflatable article. The “green” rubber article is then vulcanized in a mold at temperatures above about 160° C. to form the final inflatable article.

During manufacture, it is important to maintain the green strength of the rubber while it is being manipulated. If the green strength is too low, the rubber will tend to break, potentially resulting in defects in the final product. To overcome this problem, manufacturers have used various rubber formulations including amines, plasticizers, lubricants, resins, and blends of unsaturated polymers to improve the tackiness of the rubber. Isobutylene-based polymers have also been blended with numerous rubber formulations to increase the elasticity, strength, and/or gas impermeability of the rubber. For example, rubber compositions including 80% polyisobutylene by weight and 20% ethylene-propylene-diene polymer (“EPDM”) by weight have been used to improve the green strength of rubber articles. Unfortunately, the addition of such ingredients has been shown to have a detrimental effect on certain gas retention properties of the final inflatable article.

### SUMMARY OF THE INVENTION

In accordance with the teachings of the present invention, an inflatable article having reduced gas permeability and a method of reducing the gas permeability of an inflatable article are provided. In a particular embodiment of the present invention, the inflatable article comprises approximately 100% polyisobutylene rubber. In accordance with another embodiment of the present invention, a method of reducing the gas permeability of an inflatable article comprises inflating the inflating article with carbon dioxide to a first pressure, purging the carbon dioxide from the article, inflating the article with air to a second pressure, the second pressure being higher than the first pressure, maintaining the inflation of the article with air at the second pressure for a predetermined period of time, purging the article of air, and reinflating the article with air.

A technical advantage of particular embodiments of the present invention includes an inflatable article having reduced gas permeability. For example, in particular embodiments, inflatable articles in accordance with the teachings of the present invention exhibit reduced overall gas seepage rates at steady state. This means articles in accordance with particular embodiments of the present invention may stay inflated with an adequate pressure for longer periods of time. In the case of tires (such as bicycle tires), this means a user may need to reinflate his or her tires less frequently.

Another technical advantage of particular embodiments of the present invention includes an inflatable article having a reduced gas seepage rate after inflation with carbon dioxide, particularly after being initially inflated with air. In particular embodiments, the inflatable articles exhibit carbon dioxide gas seepage rates us to six times lower than convention blended rubber inflatable articles. Thus, particular embodiments of the present invention may be particularly useful in situations where a user reinflates a tire with carbon dioxide. The lower carbon dioxide seepage rate means the tire may remain inflated with the carbon dioxide (or a combination of carbon dioxide and air) for longer periods of time before requiring reinflation.

Other technical advantages of the present invention may be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and features and advantages thereof, reference is now made to the following description, taken in conjunction with the accompanying drawings, in which:

FIG. 1 is a flowchart of a method of reducing the gas permeability of an inflatable article in accordance with a particular embodiment of the present invention; and

FIG. 2 is a chart comparing the gas seepage rate of an inflatable article in accordance with a particular embodiment of the present invention with the gas seepage rate of a inflatable article made of conventional blended rubber.

### DETAILED DESCRIPTION OF THE INVENTION

In accordance with the teachings of the present invention, an inflatable article having reduced gas permeability and a method of reducing the gas permeability of an inflatable article are provided. In a particular embodiment of the present invention, the inflatable article comprises approximately 100% polyisobutylene rubber. In accordance with another embodiment of the present invention, a method of reducing the gas permeability of an inflatable article comprises inflating the inflating article with carbon dioxide to a first pressure, purging the carbon dioxide from the article, inflating the article with air to a second pressure, the second pressure being higher than the first pressure, maintaining the inflation of the article with air at the second pressure for a predetermined period of time, purging the article of air, and reinflating the article with air. Inflatable articles manufactured in accordance with particular embodiments of the present invention offer improved air retention, in some embodiments offering a 30% improvement in air retention over conventional blended rubber articles. In particular embodiments, the inflatable articles also show improved carbon dioxide retention.

As used herein, “inflatable article” refers to an inner tube, tire, balloon, float, inflatable boat, or any other article comprising a bladder or other expandable container that is capable of being inflated with a gas.

Generally, inflatable articles in accordance with the teachings of the present invention comprise a rubber or polymeric content that is above about 90% polyisobutylene rubber by weight. In particular embodiments, the inflatable articles may comprise above about 95% polyisobutylene rubber by weight. In particular embodiments, the inflatable articles may also comprise above about 99% polyisobutylene rubber by weight. In other embodiments, the inflatable articles essentially consist of 100% polyisobutylene rubber. Generally, the polyisobutylene rubber may be produced by any suitable industrial process. In embodiments comprising less than 100% polyisobutylene, the remainder of the rubber composition may comprise natural rubber, unsaturated polymers, semi-unsaturated polymers, semi-crystalline polymers, amines, plasticizers, lubricants, and/or resins.

In particular embodiments of the present invention, inflatable articles in accordance with the present invention are manufactured by putting the unvulcanized polyisobutylene rubber through a kneading/blending process using with a Banbury mixer. The rubber is then drawn into a thick film through large rollers that are typically maintained at approximately 70° C. The resulting batch of unvulcanized rubber is aged for a period of time and then broken into workable pieces that are fed into a hot extruder, where the rubber is filtered and extruded at temperatures ranging from about 100° C. to about 110° C. The rubber is then cooled and fed into another extruder to be made into tubes that are cooled, cut, and patched with other components, such as a valve patch, to make the desired inflatable article. The “green” rubber article is then vulcanized in a mold at temperatures above about 160° C. to form the final inflatable article.

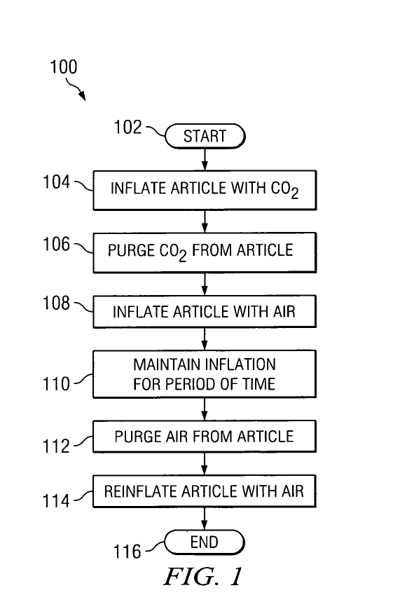

In particular embodiments of the present invention, the gas impermeability of the article may be further increased by subjecting the article to a series of inflations and purges with selected gases. Flowchart 100, shown in FIG. 1, illustrates one such process in accordance with the teachings of the present invention.

After flowchart 100 begins at step 102, the inflatable article is inflated to a first pressure with carbon dioxide at step 104. The carbon dioxide is then purged from the article at step 106. The article is then inflated to a second, higher, pressure with air at step 108. After maintaining the inflation of the article with air at the second pressure for a predetermined period of time at step 110, the inflatable article is then purged of air at step 112. Finally, at step 114, the article is reinflated with air, and the process ends at step 116.

By manufacturing inflatable articles in accordance with the teachings of the present invention (either with or without using the series of inflations and purgings described in regard to FIGS. 1 & 2), significant improvements in air and carbon dioxide retention may be obtained. In particular embodiments, the improved polyisobutylene articles of the present invention exhibit 30% better air retention than convention blended rubber articles. The improved polyisobutylene articles may also offer lower air seepage rates and/or lower carbon dioxide seepage rates, take longer times to reach a steady state carbon dioxide permeance, and take less time to reach steady state air permeance. These articles may be of particular use where air seepage and carbon dioxide seepage are of particular concern.

### EXAMPLE

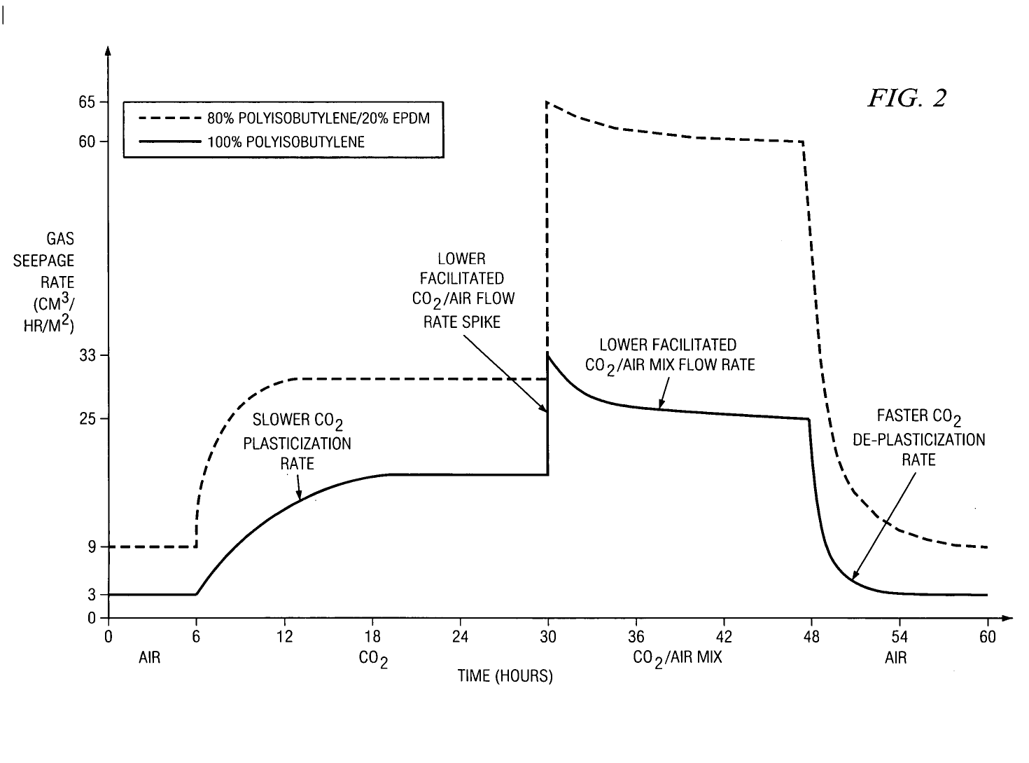

Sample compositions of rubber where prepared using traditional methods, one comprising 80% polyisobutylene and 20% ethylene-propylene-diene polymer (“EPDM”) by weight and one comprising 100% polyisobutylene. These compositions were then formed into bicycle inner tubes and subject to a variety of inflations, purges, and reinflations over several hours. FIG. 2 is a graph illustrating the gas seepage rates of the two bicycle inner tubes under these test conditions.

Initially, the two inner tubes were inflated with air and their gas seepage rates monitored for a period of 6 hours. During this time, the polyisobutylene/EPDM tube exhibited a gas seepage rate of 9 cm³/hr/m², while the 100% polyisobutlyene tube exhibited a gas seepage rate of 3 cm³/hr/m².

The two inner tubes were then inflated with carbon dioxide and monitored for a period of 24 hours. During this time, the polyisobutylene/EPDM tube reached a steady state gas permeance after 6 hours (i.e., at 12 hours on FIG. 2), while the 100% polyisobutylene tube reached a steady state gas permeance after 12 hours (i.e., at 18 hours on FIG. 2).

After both inner tubes reached a steady state permeance, the tubes were then saturated with carbon dioxide and re-inflated air. The resulting air permeance facilitation spikes can be seen at 30 hours on FIG. 2. As shown in FIG. 2, the 100% polyisobutylene tube exhibited a much lower spike of 33 cm³/hr/m², compared to 65 cm³/hr/m² for the polyisobutylene/EPDM tube.

After being saturated with carbon dioxide and reinflated with a carbon dioxide-air mixture, the 100% polyisobutylene tube also exhibited a lower steady state gas permeance than the polyisobutylene/EPDM tube (e.g., 25 cm³/hr/m² for the 100% polyisobutylene compared to 60 60 cm³/hr/m² for the polyisobutylene/EPDM). Additionally, the 100% polyisobutylene tube required less time to reach a steady state air permeance (e.g., 6 hours) than the polyisobutylene/EPDM tube (e.g., 12 hours).

Therefore, as shown by these results, the improved polyisobutylene articles of the present invention (e.g., those essentially consisting of polyisobutylene) are well adapted to attain the ends and advantages mentioned as well as those which are inherent therein. Although particular embodiments of the method and apparatus of the present invention have been illustrated in the accompanying drawings and described in the foregoing detailed description, it will be understood that the invention is not limited to the embodiments disclosed, but is capable of numerous rearrangements, modifications, and substitutions without departing from the spirit of the invention as set forth and defined by the following claims.

What is claimed is:

1. An inflatable article essentially consisting of polyisobutylene rubber.

2. The article of claim 1, wherein the inflatable article is selected from the group consisting of a inner tube, a tire, a balloon, a float, and an inflatable boat.

3. An inflatable article comprising more than about 90% polyisobutylene rubber by weight.

4. The article of claim 3, wherein the inflatable article comprises more than about 95% polyisobutylene rubber by weight.

5. The article of claim 3, wherein the article comprises more than about 99% polyisobutylene rubber by weight.

6. The article of claim 3, wherein the article comprises about 100% polyisobutylene rubber.

7. The article of claim 3, wherein the inflatable article is selected from the group consisting of a inner tube, a tire, a balloon, a float, and an inflatable boat.

8. A method of reducing the gas permeability of an inflatable article, comprising:
inflating an inflating article with carbon dioxide to a first pressure;
purging the carbon dioxide from the article;
inflating the article with air to a second pressure, the second pressure being higher than the first pressure;
maintaining the inflation of the article with air at the second pressure for a predetermined period of time;
purging the article of air; and
reinflating the article with air.

9. The method of claim 8, wherein the inflatable article consists of polyisobutylene rubber.

10. The method of claim 8, wherein the inflatable article essentially consists of polyisobutylene rubber.

11. The method of claim 8, wherein the inflatable article comprises of polyisobutylene rubber.

12. The method of claim 11, wherein the inflatable article comprises more than about 90% polyisobutylene rubber by weight.

13. The method of claim 11, wherein the inflatable article comprises more than about 95% polyisobutylene rubber by weight.

14. The method of claim 11, wherein the inflatable article comprises more than about 99% polyisobutylene rubber by weight.

15. The method of claim 11, wherein the inflatable article comprises about 100% polyisobutylene.

16. The method of claim 8, wherein the inflatable article is selected from the group consisting of a inner tube, a tire, a balloon, a float, and an inflatable boat.
